(19) United States
(12) Patent Application Publication
(10) Pub. No.: US 2012/0036966 A1
(43) Pub. Date: Feb. 16, 2012

(54) RATCHET WRENCH WITH REVERSIBLE MECHANISM

(76) Inventor: Hong-Jen Lee, Taichung (TW)

(21) Appl. No.: 12/853,298

(22) Filed: Aug. 10, 2010

(51) Int. Cl. B25B 13/46

(52) U.S. Cl. 81/62

(57) ABSTRACT

The present invention relates to a ratchet wrench comprising a main body, a driving head, three pawls, a knurled rotatable disc, a linkage piece and a locking element. The driving head has a columned limit portion, and a polygonal columned couple portion for coupling a workpiece. The limit portion has three tangent planes with equal central angles each forming a recess cut for each pawl located. The linkage piece links the limit portion and penetrates the knurled rotatable disc to link with the locking element. The limit portion is mounted by a mounting piece which has three first sliding slots and three rails bored on it. Each pawl is guided by a relative rail, and has a rod extended upwards. The rod links to an elastic element which provides elasticity for the rod to move in radial direction. When the knurled rotatable disc is turned clockwise or counterclockwise to interact with the rod, the rod triggers the pawl to laterally move clockwise or counterclockwise, and the retaining cogs on one side of the pawl are, therefore, engaged with the ratchet teeth to control the driving head being turned clockwise or counterclockwise.

### FIELD OF THE INVENTION

The present invention relates to a ratchet wrench, particularly to a wrench whose driving head is capable of being turned clockwise and counterclockwise.

### BACKGROUND OF THE INVENTION

For a conventional ratchet wrench structure, such as U.S. Pat. No. 4,497,227, the lateral side of the driving head holds one or two pawls. The retaining teeth of the pawl engage with the ratchet teeth on the inner wall of the head portion of the main body, and an upper lid is disposed on the head portion, and connected with a spring. One end of the spring connects the pawl. The rotation of the upper lid controls the spring to rotate. Then, the spring pushes the pawl to swing and engage with the ratchet teeth of the head portion by retaining teeth on left side or right side, and further control the driving head having the ability of clockwise or counterclockwise drive.

However, the disadvantages of the above-mentioned US patent are as followings:

1. Controlling the ratchet wrench to make clockwise or counterclockwise turn relies on the upper lid to push the spring which makes the pawl to swing. During operation, the spring must bear a bigger reaction. It is easy to get elastic fatigue, and the retaining teeth of the pawl cannot properly engage with the ratchet teeth.

2. It is necessary to machine the upper lid to get a receiving chamber to hold the spring. However, the upper lid is not a circle. It requires milling. However, milling will increases the machining time and the cost of fabrication.

3. The actuation principle of the ratchet wrench requires a certain length of spring to fit an elastic action being produced when the retaining teeth of the pawl and the wretch gear are not relatively in mesh. The upper lid needs to receive a spring, and has a bigger diameter. Thus, the head portion of the wrench also needs a matching diameter. Therefore, one size of the upper lid and the pawl cannot fit different sizes of the wrench.

4. For assembling, if the two springs are firstly assembled with the pawl, and then the upper lid is assembled, it is not easy to align the two springs because the receiving chamber faces downward. It causes an assembling inconvenience.

There is another ratchet wrench disclosed in U.S. Pat. No. 6,769,330, whose operational end of the main body holds one driving head. The two lateral sides of the driving head hold two pawls. The retaining teeth of the pawl engage with the ratchet teeth on the inner wall of the main body. The two pawls are connected and positioned by two elastic elements. The advantage of the patent is that the elastic elements are wound around the periphery of the driving head. Thus, the elastic elements avoid the disadvantage that the spring mentioned in U.S. Pat. No. 4,497,227 occupies the space. However, the disadvantage of the aforementioned patent is: the elastic element is in form of wire, one end of the elastic element is disposed on the driving head and the other end is connected to the pawl, so that the ratchet wench is unable to make a clockwise or counterclockwise driving. In other words, the pawl cannot swing except one directional rotation. If the user wants to get another direction of rotation, he has to turn over the ratchet wrench to another side for use. Thus, the ratchet wrench of U.S. Pat. No. 6,769,330 is inconvenient in use.

Another prior art of a ratchet wrench disclosed in Taiwan Patent Application No. 096219094, the ratchet wrench is a hand tool that adopts a ratchet wheel as a driving device. On one side of the hand tool is an adjustable operation unit to be operated in accordance with its component-assembly, and on the other side is a driving unit which has a housing with ratchet teeth on its inner wall. There is a rotatable member located within the housing with a couple opening. The outer periphery of the rotatable member has a plurality of movable tangent planes equally arranged to be lain by limit members. At the outer portion of each limit member are retaining cogs relatively engaged with the ratchet teeth, and at the inner portion is a surface resting against a tangent plane of the rotatable member. There are two linkages extended from the top and the bottom of the limit member to link with both sides of the tangent plane respectively. Two annular cover pieces are applied on both sides of the housing to conceal the limit members and the rotatable member. Although the prior art has three sets of retaining cogs and, therefore, has stabler rotary ability than the ratchet wrench with two sets of retaining cogs. Inasmuch as its linkage links the rotatable member at one side and the retaining cogs at the other side, it can only drive the cogs to move in single direction. If it requires to operate in the reverse direction, the wrench needs to be turned upside down. The disadvantage of the prior art is that it is inconvenient for users to operate the hand tool with single direction driving.

### SUMMARY OF THE INVENTION

The object of the present invention is to provide a ratchet wrench comprising three pawls, which are interacted for controlling its reversing mechanism, in order to evenly distribute the force exerted over the wrench. Generally described, a ratchet mechanism according to the present invention includes a main body, a driving head, three pawls, a knurled rotatable disc, a linkage piece and a locking element. The middle part of the driving head is a disc which has a polygonal columned couple portion extended from the bottom of the disc for a workpiece to be coupled and a columned limit portion extended from the top center of the disc. The periphery of the limit portion has three tangent planes with equal central angles. Each tangent plane and the top of the disc forms a recess cut, and each pawl is respectively located within a recess cut. When the knurled rotatable disc is turned against an annular head portion, it drives the pawls to be engaged with ratchet teeth. The bottom of the linkage piece links the limit portion, and its top penetrates the knurled rotatable disc to link with the locking element. The limit portion is mounted by a mounting piece and the mounting piece has three first sliding slots and three rails bored on its top. Each pawl is guided by a relative rail and its top extends a rod upwards. Each rod is hooked by an elastic element which provides elasticity for the rod to move in radial direction. Therefore, the knurled rotatable disc is able to interact with the rod and to be turned against the limit portion. When the knurled rotatable disc is turned clockwise or counterclockwise, one side of each pawl or its retaining cogs on the other side are able to be engaged with the ratchet teeth by means of interaction between the rod and the pawl for the pawl to move laterally, clockwise or counterclockwise, along its relative rail and tangent plane.

### BRIEF DESCRIPTION OF THE DRAWINGS

FIG. 1 is an exploded drawing of the first embodiment in accordance with the present invention;

FIG. 2 is a partial assembled drawing of the first embodiment in accordance with the present invention;

FIG. 3 is a partial assembled schematic drawing of the first embodiment in accordance with the present invention;

FIG. 4 is a top view of the first embodiment in accordance with the present invention;

FIG. 5 is a cross-sectional view taken along lines A-A in FIG. 4;

FIG. 6 is a side view of the first embodiment in accordance with the present invention;

FIG. 7 is a cross-sectional view taken along lines B-B in FIG. 6 showing pawls at one side;

FIG. 8 is a cross-sectional view taken along lines C-C in FIG. 6 showing the rotatable disc turning to a certain angle;

FIG. 9 is a cross-sectional view taken along lines B-B in FIG. 6 showing pawls at the other side;

FIG. 10 is a cross-sectional view taken along lines C-C in FIG. 6 showing the rotatable disc turning to another angle;

FIG. 11 is an exploded drawing of the second embodiment in accordance with the present invention;

FIG. 12 is an exploded drawing of the third embodiment in accordance with the present invention;

FIG. 13 is an exploded drawing of the fourth embodiment in accordance with the present invention;

FIG. 14 is an exploded drawing of the fifth embodiment in accordance with the present invention;

FIG. 15 is a cross sectional view of the fifth embodiment in accordance with the present invention;

FIG. 16 is an exploded drawing of the sixth embodiment in accordance with the present invention;

FIG. 17 is a partial assembled drawing of the sixth embodiment in accordance with the present invention; and

FIG. 18 is a cross sectional view of the sixth embodiment in accordance with the present invention.

### DETAILED DESCRIPTION OF THE PREFERRED EMBODIMENT

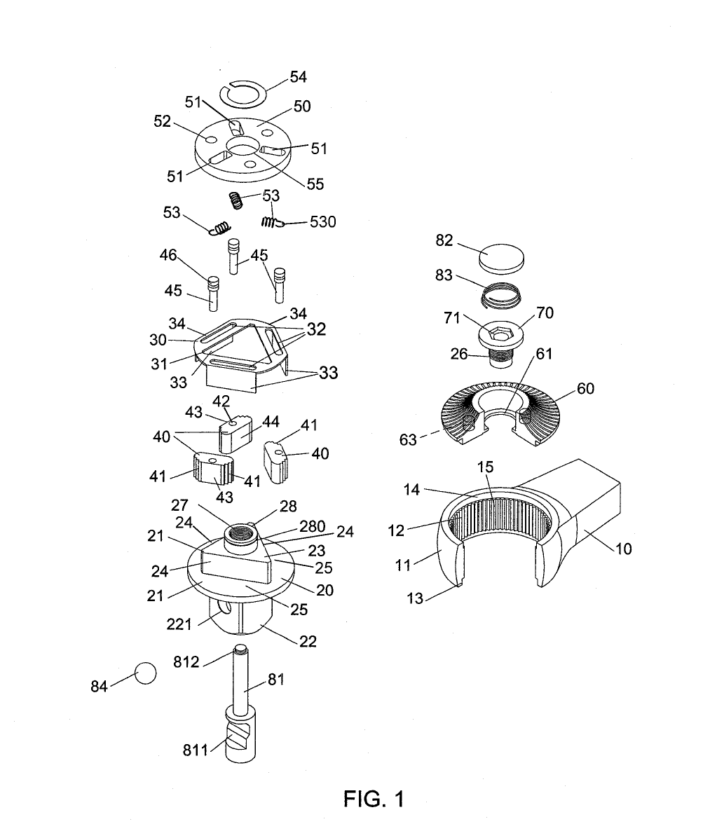

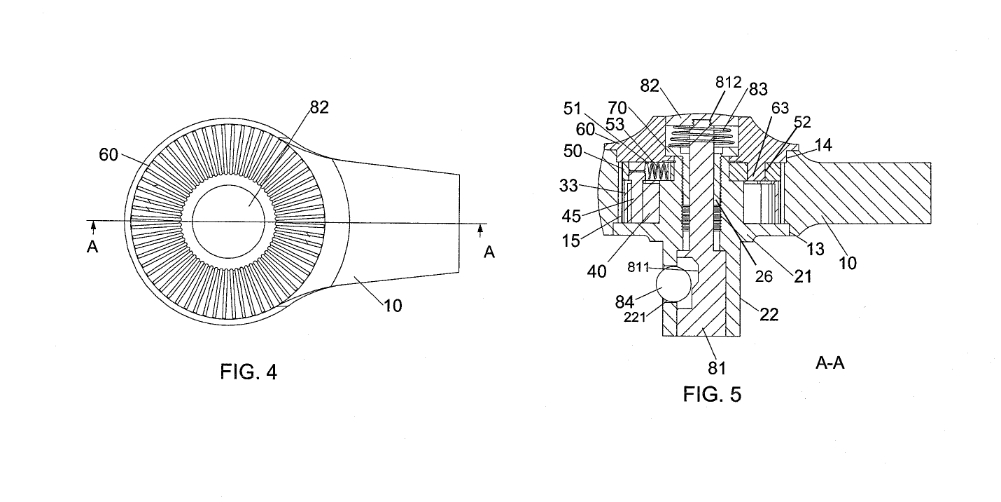

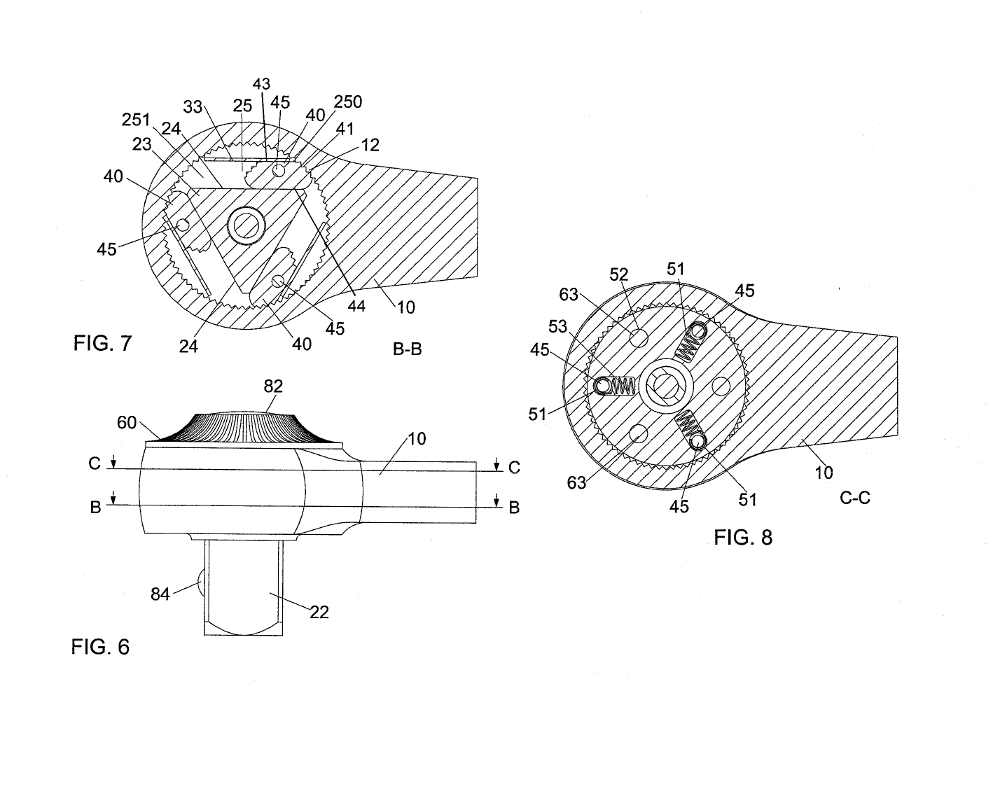

Referring to FIG. 1 to FIG. 10, in order to achieve the objects mentioned above, the basic structure of the ratchet wrench includes a main body 10, a driving head 20, three pawls 40, a knurled rotatable disc 60, a linkage piece 26 and a locking element 70. There is an annular head portion 11 vertically inserted in a circular housing 15, whose inner wall has a plurality of ratchet teeth 12, at one end of the main body 10. The driving head 20 is rotatably located within the circular housing 15, and its middle portion is a disc 21 which shares the same axis with the circular housing 15. The periphery of the disc 21 is engaged with the bottom of the circular housing 15. There is a polygonal columned couple portion 22 extended downwards from the center bottom of the disc 21 for a workpiece to be coupled, and there is also a columned limit portion 23 extended upwards from the top center of the disc 21. The periphery of the limit portion 23 has three tangent planes 24 with equal central angles against the center axis of the limit portion 23. Each tangent plane 24 and the top of the disc 21 form a recess cut 25, and each pawl 40 is respectively located within a recess cut 25. The knurled rotatable disc 60 is rotatably topped on the circular housing 15. When the knurled rotatable disc 60 is turned against the annular head portion 11, it drives the pawls 40 to be engaged with ratchet teeth 12. The linkage piece 26 and the disc 21 share the same axis. The bottom of the linkage piece 26 links the limit portion 23, and its top end penetrates through a first linkage duct 61 at the center of the knurled rotatable disc 60 to link with the locking element 70.

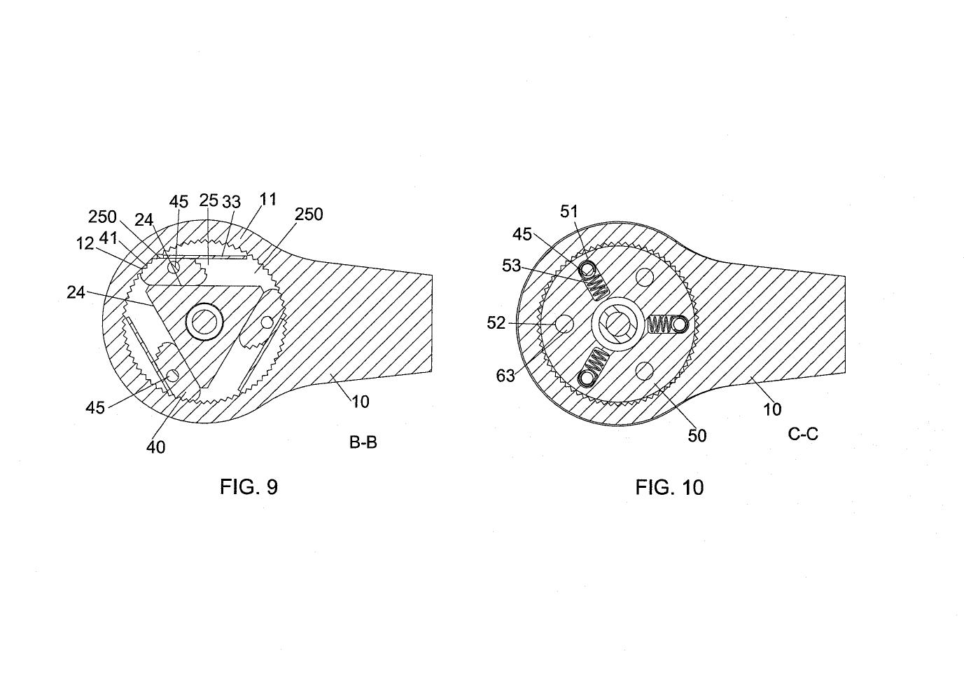

Features of the basic structure are: the limit portion 23 being mounted by a mounting piece 30 which also covers the top of the recess cut 25, three first sliding slots 32 and three rails 33 being arranged with equal central angles against the center axis of the mounting piece 30, each first sliding slot 32 being extended relative to a rail 33 in parallel and the direction to extend the rail 33 being in parallel with a tangent to the disc; each pawl 40 being guided by a relative rail 33 and having a front plane 43 and a back plane 44 opposite to each other, the front plane 43 having retaining cogs 41 on its two vertical sides and the back plane 44 being lain back against the tangent plane 24, each pawl 40 also extending a rod 45 upwards on its top, the middle portion of the rod 45 penetrating a relative first sliding slot 32 and its top portion linking to one end of an elastic element 53 which provides elasticity for the rod 45 to move in radial direction, therefore, the knurled rotatable disc 60 being able to interact with the rod 45 and to be turned against the limit portion 23; shown as FIG. 7 and FIG. 8, when the knurled rotatable disc 60 being turned clockwise to interact with the rod 45, the rod 45 triggering the pawl 40 to laterally move clockwise as well along the rail 33 and the tangent plane 24, and furthermore, the retaining cogs 41 on one side of the pawl 40 being engaged with the ratchet teeth 12; shown as FIG. 9 and FIG. 10, when the knurled rotatable disc 60 being turned counterclockwise, the pawl 40 laterally move counterclockwise as well along the rail 33 and the tangent plane 24 to the opposite direction and its retaining cogs 41 on the other side being engaged with the ratchet teeth 12 then.

Referring to FIG. 1, in one of the embodiments of the present invention, there is a rotatable disc 50 located on the top of the mounting piece 30 which mounted over the limit portion 23. The rotatable disc 50 and the mounting piece 30 share the same axis, and there are three second sliding slots 51 arranged with equal central angles against the center axis on the rotatable disc 50. The second sliding slot 51 is extended along the radial direction of the center axis of the rotatable disc 50, and each second sliding slot 51 is corresponding to a first sliding slot 32. The top portion of the rod 45 penetrates through one side of a relative second sliding slot 51 and hooks onto one end of the elastic element 53, and the other end of the elastic element 53 is against the inner wall of the other end of the second sliding slot 51. Wherein, on the rotatable disc 50 is at least one round trough 52, and on the bottom of the knurled rotatable disc 60 is at least one extruded cylinder 63 which is inserted into the round trough 52 for the rotatable disc 50 and the knurled rotatable disc 60 to interlink together. Furthermore, at one end of the elastic element 53 is a loop 530 which is employed to snap in a groove 46 at the top portion of the rod 45.

Referring to FIG. 1, in one of the embodiments of the present invention, there is a hollow duct 27 bored downwards from the top center of the limit portion 23, and there is a screw-thread section in the hollow duct 27. The linkage piece 26 is part of the locking element 70 and its outer periphery also has a screw-thread section to couple with the inner screw-thread section of the hollow duct 27. Furthermore, on the top center of the limit portion 23 is an extruded cylinder 28 whose outer periphery has a first annular groove 280 at its end. The end portion of the extruded cylinder 28 penetrates through a cylinder duct 55 in the center of the rotatable disc 50, and its first annular groove 280 is snapped by a C-clip 54 at the top of the rotatable disc 50 to limit the cylinder.

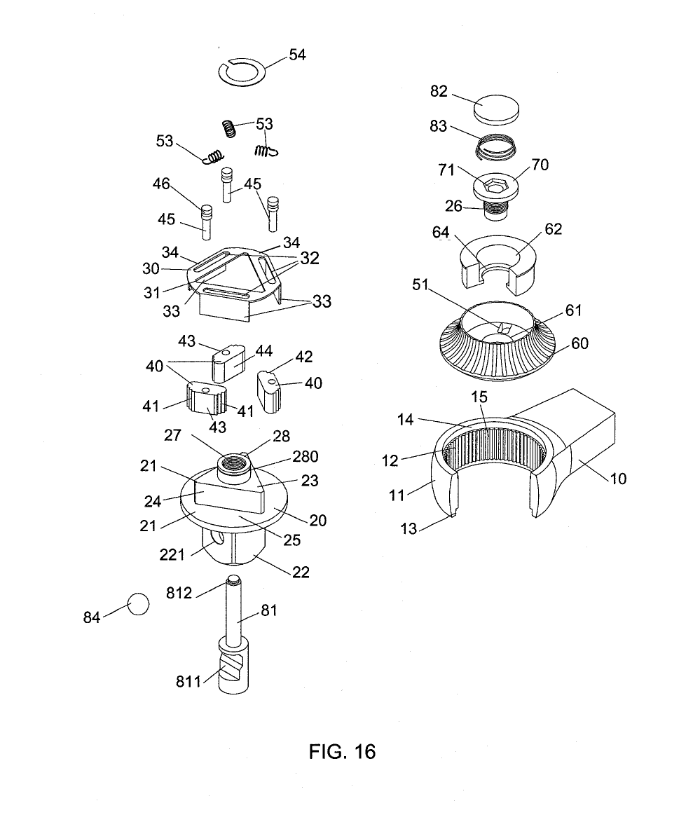

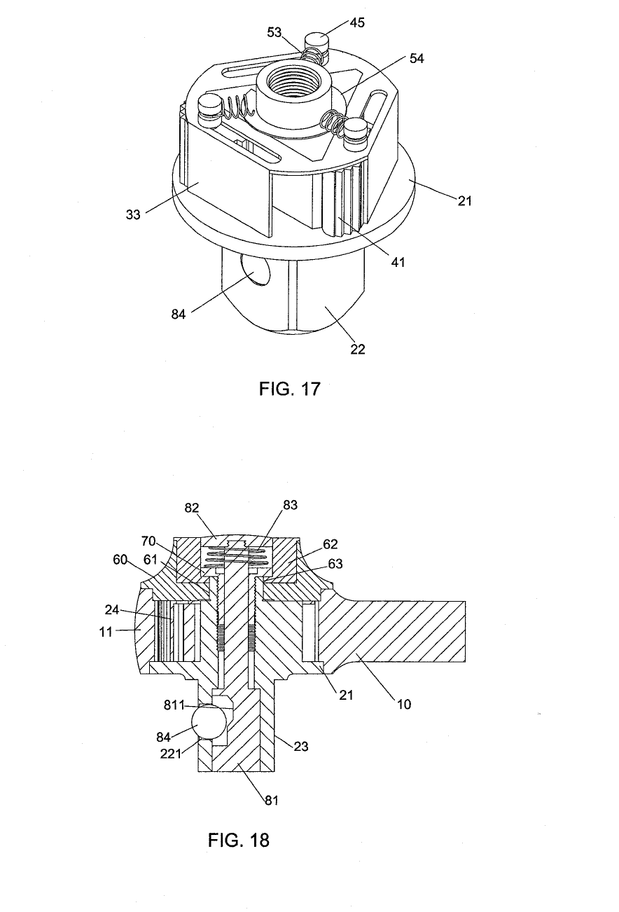

Referring to FIG. 16 to FIG. 18, in one of the embodiments of the present invention, the knurled rotatable disc 60 is placed on the top of the limit portion 23. There are three second sliding slots 51 arranged with equal central angles against the center axis on the knurled rotatable disc 60. The second sliding slot 51 is extended along the radial direction of the center axis, and each second sliding slot 51 is corresponding to a first sliding slot 32. The top portion of the rod 45 penetrates through one side of a relative second sliding slot 51 and hooks onto one end of the elastic element 53, and the other end of the elastic element 53 is against the inner wall of the other end of the second sliding slot 51. Wherein, the second sliding slots 51 are vertically bored in the knurled rotatable disc 60 and a concealment member 62 is allocated within the knurled rotatable disc 60 to conceal the second sliding slots 51. The concealment member 62 has a second linkage duct 64 for the linkage piece 26 to penetrate and the locking element 70 is locked on the top of the concealment member 62.

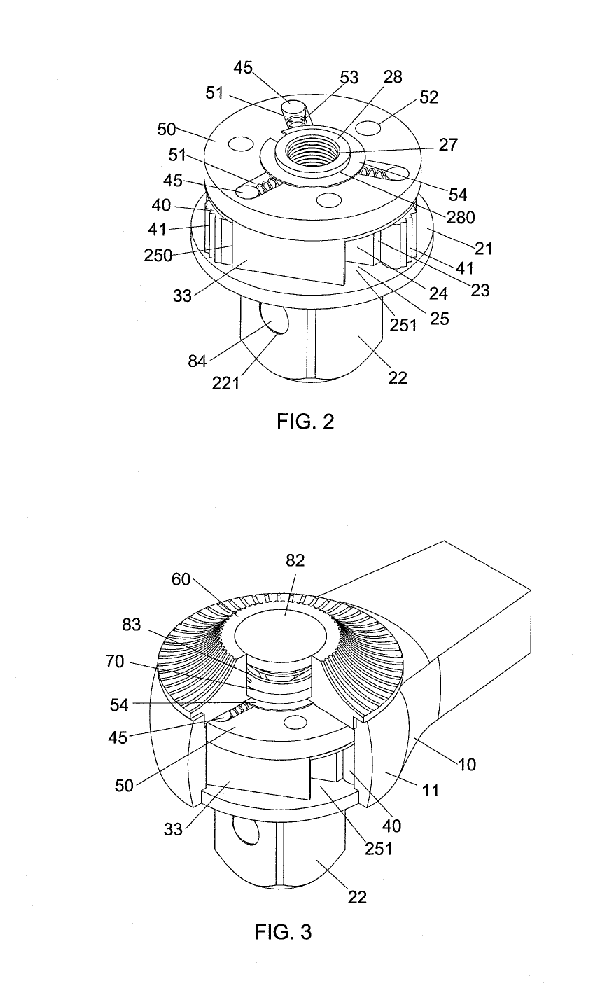

Referring to FIG. 1 and FIG. 2, in one of the embodiments of the present invention, the mounting piece 30 includes a mounting opening 31 at its center and three edge slabs 34 arranged with equal central angles against the center axis. The mounting opening 31 is mounted over the limit portion 23 to be fixed in position. Each first sliding slot 32 is allocated corresponding to an edge slab 34 and each rail 33 is extended downwards from the edge slab 34. Therefore, each recess cut 25 is embraced by the edge slab 34, the disc 21, the rail 33 and the tangent plane 24 as its top, bottom, front plane and back plane respectively. Meanwhile, two gaps 250/251 are formed at both vertical sides of the recess cut 25. The front plane 43 of each pawl 40 is lain against the rail 33. When the pawl 40 moves right side against the limit portion 23, the retaining cogs 41 reaches out of the gap 250 from the recess cut 25 to engage with the ratchet teeth 12. When the pawl 40 moves left side against the limit portion 23, the retaining cogs 41 reaches out of the other gap 251 from the recess cut 25 to engage with the ratchet teeth 12. Wherein, four sides of each first sliding slot 32 are self-contained to form a long slot, and the bottom of each rail 33 rests on the top of the disc 21.

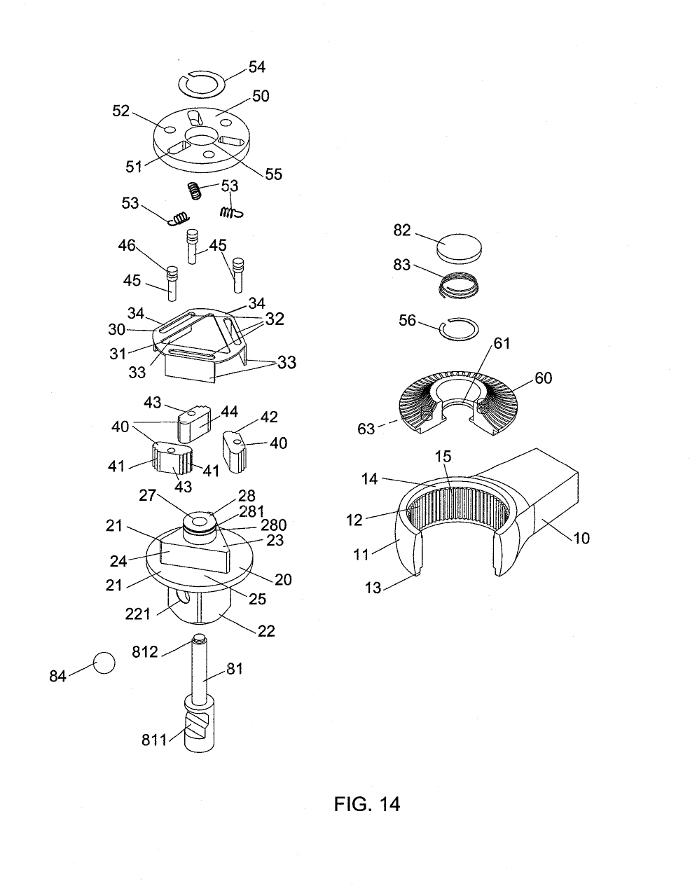

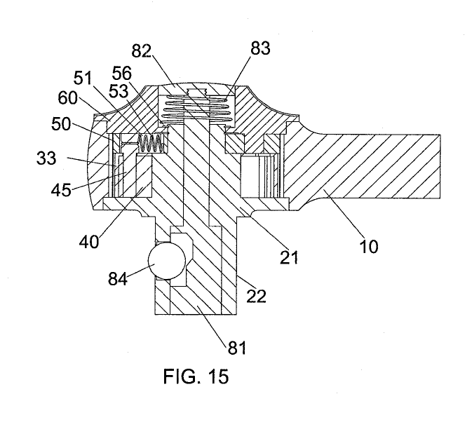

Referring to FIG. 14 to FIG. 15, in one of the embodiments of the present invention, the linkage piece 26 is integrated with the limit portion 23 on its top and the outer periphery of the linkage piece 26 has a second annular groove 281 at its end. The end portion of the linkage piece 26 penetrates the knurled rotatable disc 60 through the first linkage duct 61, and the second annular groove 281 is snapped by a C-clip 56 at the top of the knurled rotatable disc 60 to limit the linkage piece 26. Shown as the drawings, the rotatable disc 50 is located on the mounting piece 30. On the top center of the limit portion 23 is an extruded cylinder 28 which is integrated with the linkage piece 26. The outer periphery of the extruded cylinder 28 has a first annular groove 280 at its end. The end portion of the extruded cylinder 28 penetrates through a cylinder duct 55 in the center of the rotatable disc 50, and its first annular groove 280 is snapped by a C-clip 54 at the top of the rotatable disc 50 to limit the cylinder.

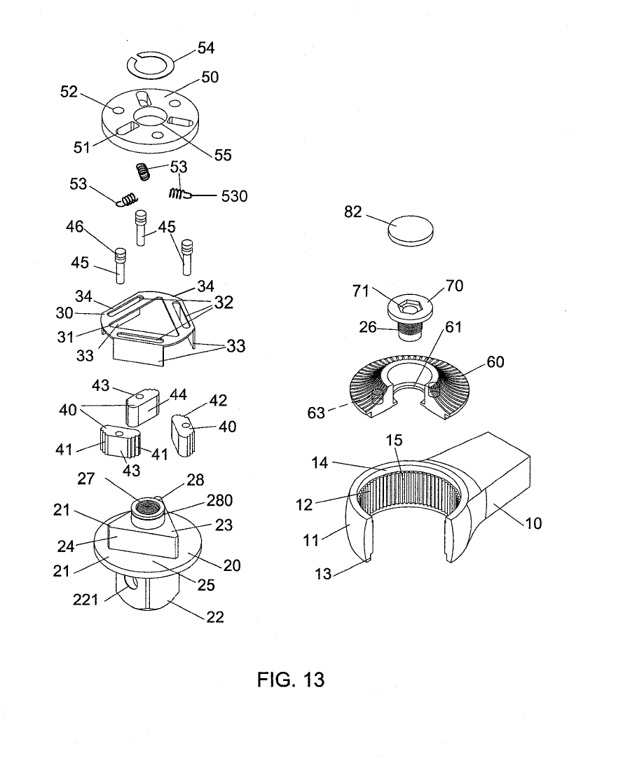

Referring to FIG. 1 and FIG. 5, there is a better embodiment of the present invention comparing to the embodiment shown in FIG. 13. A hollow duct 27 is bored downwards from the top center of the limit portion 23, and a spheroid hole 221 is bored on the periphery of the couple portion 22 to communicate with the hollow duct 27. A control shaft 81 is vertically inserted through the hollow duct 27, and its outer periphery at the bottom portion has a spheroid trough 811 corresponding to the spheroid hole 221 in the couple portion 22. The inner wall of the spheroid trough 811 is ladder-like. At the top portion of the control shaft 81 is a screw-thread section 812. Inasmuch as the control shaft 81 protrudes from the top of the hollow duct 27 and then links into both the linkage piece 26 and the shaft duct 71 of the locking element 70, the screw-thread section 812 exposes above the locking element 70 and couples with the thread-couple element 82. There is a spring 83 applied between the thread-couple element 82 and the locking element 70, and there is a spheroid 84 allocated between the spheroid hole 221 and the spheroid trough 811.

Referring to FIG. 1 and FIG. 2, in a better embodiment of the present invention, the limit portion 23 is designed as a triangular column with three tangent planes 24 in order to economize material cost and manufacture with convenience. Referring to FIG. 1 and FIG. 2, in a better embodiment of the present invention, there are one first annular trough 14 and one second annular trough 13, which are extended outwards with diameters larger than the housing, on the top and the bottom of the circular housing 15 respectively. The first annular trough 14 allows the knurled rotatable disc 60 to be mounted and the second annular trough 13 provides a recess for the disc 21.

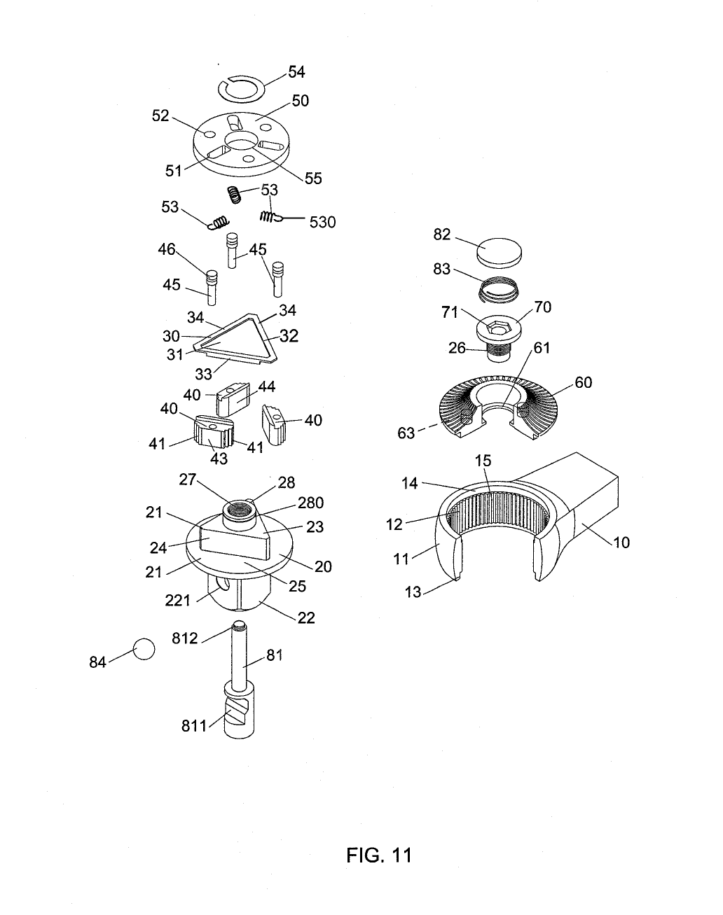

Referring to FIG. 11, in one of the embodiments of the present invention, the rail 33 of the mounting piece 30 is formed by partially extending the outer periphery of the mounting piece 30.

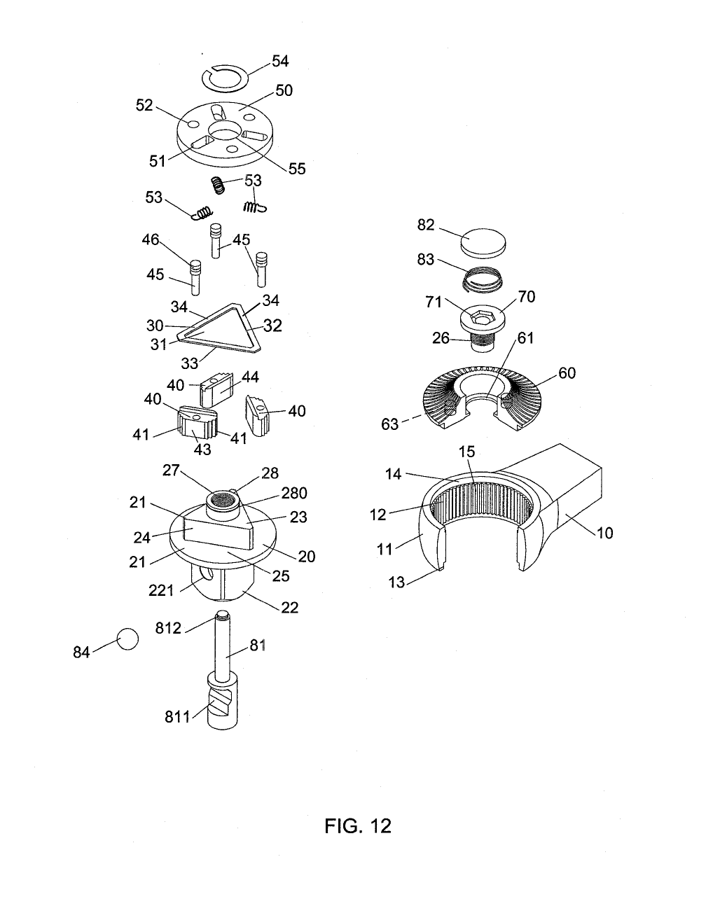

Referring to FIG. 12, in one of the embodiments of the present invention, the rail 33 of the mounting piece 30 is formed by directly linking to the edge of the mounting piece 30.

While we have shown and described the embodiment in accordance with the present invention, it should be clear to those skilled in the art that further embodiments may be made without departing from the scope of the present invention.

1. A ratchet wrench comprising:
a main body 10 with an annular head portion 11 vertically inserted in a circular housing 15, whose inner wall has a plurality of ratchet teeth 12, at one end of the main body 10;
a driving head 20 rotatably located within the circular housing 15 and its middle portion being a disc 21 which shares the same axis with the circular housing 15, the periphery of the disc 21 being engaged with the bottom of the circular housing 15, a polygonal columned couple portion 22 extending downwards from the center bottom of the disc 21 for a workpiece to be coupled, a columned limit portion 23 also extending upwards from the top center of the disc 21, the periphery of the limit portion 23 having three tangent planes 24 with equal central angles, and each tangent plane 24 and the top of the disc 21 forming a recess cut 25;
three pawls 40 being respectively located within a recess cut 25;
a knurled rotatable disc 60 being rotatably topped on the circular housing 15, as the knurled rotatable disc 60 being turned against the annular head portion 11, it driving the pawls 40 to be engaged with ratchet teeth 12;
a linkage piece 26 sharing the same axis with the disc 21, the bottom of the linkage piece 26 linking the limit portion 23, and its top penetrating a first linkage duct 61 at the center of the knurled rotatable disc 60 to link with a locking element 70;
wherein:
the limit portion 23 being mounted by a mounting piece 30 which also covers the top of the recess cut 25, three first sliding slots 32 and three rails 33 being arranged with equal central angles against the center axis on the mounting piece 30, each first sliding slot 32 being extended relative to a rail 33 in parallel and the direction to extend the rail 33 being in parallel with a tangent to the disc; each pawl 40 being guided by a relative rail 33 and having a front plane 43 and a back plane 44 opposite to each other, the front plane 43 having retaining cogs 41 on its two vertical sides and the back plane 44 being lain back against the tangent plane 24, each pawl 40 also extending a rod 45 upwards on its top, the middle portion of the rod 45 penetrating a relative first sliding slot 32 and its top portion linking to one end of an elastic element 53 which provides elasticity for the rod 45 to move in radial direction, therefore, the knurled rotatable disc 60 being able to interact with the rod 45 and to be turned against the limit portion 23; as the knurled rotatable disc 60 being turned clockwise to interact with the rod 45, the rod 45 triggering the pawl 40 to laterally move clockwise as well along the rail 33 and the tangent plane 24, and the retaining cogs 41 on one side of the pawl 40 being engaged with the ratchet teeth 12; and as the knurled rotatable disc 60 being turned counterclockwise, the pawl 40 laterally move counterclockwise as well along the rail 33 and the tangent plane 24 to the opposite direction and its retaining cogs 41 on the other side being engaged with the ratchet teeth 12 then.

2. The ratchet wrench as claimed in claim 1, wherein there is a rotatable disc 50 located on the top of the mounting piece 30 which mounts over the limit portion 23; there are three second sliding slots 51 arranged with equal central angles against the center axis on the rotatable disc 50; the second sliding slot 51 is extended along the radial direction of the center axis of the rotatable disc 50 and each second sliding slot 51 is corresponding to a first sliding slot 32; the top portion of the rod 45 penetrates through one side of a relative second sliding slot 51 and hooks onto one end of the elastic element 53, and the other end of the elastic element 53 is against the inner wall of the other end of the second sliding slot 51; the rotatable disc 50 and the knurled rotatable disc 60 are interlinked together.

3. The ratchet wrench as claimed in claim 2, wherein on the rotatable disc 50 is at least one round trough 52, and on the bottom of the knurled rotatable disc 60 is at least one extruded cylinder 63 which is inserted into the round trough 52 for the rotatable disc 50 and the knurled rotatable disc 60 to interlink together.

4. The ratchet wrench as claimed in claim 2, wherein on the top center of the limit portion 23 is a extruded cylinder 28 and the outer periphery of the extruded cylinder 28 has a first annular groove 280 at its end; the end portion of the extruded cylinder 28 penetrates through a cylinder duct 55 in the center of the rotatable disc 50 and its first annular groove 280 is snapped by a C-clip 54 at the top of the rotatable disc 50 to limit the cylinder.

5. The ratchet wrench as claimed in claim 1, wherein the knurled rotatable disc 60 is placed on the top of the limit portion 23 and there are three second sliding slots 51 arranged with equal central angles on the knurled rotatable disc 60; the second sliding slot 51 is extended along the radial direction of the center axis and each second sliding slot 51 is corresponding to a first sliding slot 32; the top portion of the rod 45 penetrates through one side of a relative second sliding slot 51 and hooks onto one end of the elastic element 53, and the other end of the elastic element 53 is against the inner wall of the other end of the second sliding slot 51.

6. The ratchet wrench as claimed in claim 5, wherein the second sliding slots 51 are vertically bored in the knurled rotatable disc 60 and a concealment member 62 is allocated within the knurled rotatable disc 60 to conceal the second sliding slots 51.

7. The ratchet wrench as claimed in claim 1, wherein there is a hollow duct 27 bored downwards from the top center of the limit portion 23 and there is a screw-thread section in the hollow duct 27; and the linkage piece 26 is part of the locking element 70 and its outer periphery also has a screw-thread section to couple with the inner screw-thread section of the hollow duct 27.

8. The ratchet wrench as claimed in claim 1, wherein the mounting piece 30 includes a mounting opening 31 at its center and three edge slabs 34 arranged with equal central angles against the center axis; the mounting opening 31 is mounted over the limit portion 23 to be fixed in position; each first sliding slot 32 is allocated corresponding to an edge slab 34 and each rail 33 is extended downwards from the edge slab 34; therefore, each recess cut 25 is embraced by the edge slab 34, the disc 21, the rail 33 and the tangent plane 24 as its top, bottom, front plane and back plane respectively; two gaps 250/251 are formed at both vertical sides of the recess cut 25 and the front plane 43 of each pawl 40 is lain against the rail 33; as the pawl 40 moves clockwise, the retaining cogs 41 reaches out of the gap 250 from the recess cut 25 to engage with the ratchet teeth 12; and as the pawl 40 moves counterclockwise, the retaining cogs 41 reaches out of the other gap 251 from the recess cut 25 to engage with the ratchet teeth 12.

9. The ratchet wrench as claimed in claim 8, wherein four sides of each first sliding slot 32 are self-contained to form a long slot.

10. The ratchet wrench as claimed in claim 8, wherein the bottom of each rail 33 rests on the top of the disc 21.

11. The ratchet wrench as claimed in claim 1, wherein the linkage piece 26 is integrated with the limit portion 23 on its top and the outer periphery of the linkage piece 26 has a second annular groove 281 at its end; the end portion of the linkage piece 26 penetrates the knurled rotatable disc 60 through the first linkage duct 61 and the second annular groove 281 is snapped by a C-clip 56 at the top of the knurled rotatable disc 60 to limit the linkage piece 26.

12. The ratchet wrench as claimed in claim 1, wherein a hollow duct 27 is bored downwards from the top center of the limit portion 23 and a spheroid hole 221 is bored on the periphery of the couple portion 22 to communicate with the hollow duct 27; a control shall 81 is vertically inserted through the hollow duct 27 and its outer periphery at the bottom portion has a spheroid trough 811 corresponding to the spheroid hole 221 in the couple portion 22; the inner wall of the spheroid trough 811 is ladder-like and at the top portion of the control shaft 81 is a screw-thread section 812; inasmuch as the control shaft 81 protrudes from the top of the hollow duct 27 and then links into both the linkage piece 26 and the shaft duct 71 of the locking element 70, the screw-thread section 812 exposes above the locking element 70 and couples with the thread-couple element 82; there is a spring 83 applied between the thread-couple element 82 and the locking element 70, and there is a spheroid 84 allocated between the spheroid hole 221 and the spheroid trough 811.

13. The ratchet wrench as claimed in claim 1, wherein the limit portion 23 is designed as a triangular column with three tangent planes 24.

14. The ratchet wrench as claimed in claim 1, wherein at one end of the elastic element 53 is a loop 530 which is employed to snap in a groove 46 at the top portion of the rod 45.

15. The ratchet wrench as claimed in claim 1, wherein there is a first annular trough 14 extended outwards with a diameter larger than the housing on the top of the circular housing 15 for the knurled rotatable disc 60 to be mounted.

16. The ratchet wrench as claimed in claim 1, wherein there is a second annular trough 13 extended outwards with a diameter larger than the housing on the bottom of the circular housing 15 for the disc 21 to be mounted.
